(19) United States
(12) Patent Application Publication
(10) Pub. No.: US 2026/0106235 A1
(43) Pub. Date: Apr. 16, 2026

(54) BATTERY MANAGEMENT SYSTEM OPERATION

(71) Applicant: Infineon Technologies AG, Neubiberg (DE)

(72) Inventors: Joon Ha PARK, Seoul (KR); Ha Ram KIM, Seoul (KR)

(21) Appl. No.: 19/326,075

(22) Filed: Sep. 11, 2025

(30) Foreign Application Priority Data
Oct. 14, 2024 (DE) 102024209961.9

(51) Int. Cl. H01M 10/42

(52) U.S. Cl. CPC H01M 10/425; H01M 2010/4271; H01M 2220/20

(57) ABSTRACT

A controller is presented. The controller is configured for controlling a battery management system. The battery management system comprises a plurality of battery management subsystems in at least partially different voltage domains. The controller comprises a transceiver. The transceiver is configured for directly communicating with each battery management subsystem individually. Further, a battery management system and a method for controller controlling a battery management system are presented.

### TECHNICAL FIELD

The present disclosure relates to a controller configured for controlling a battery management system, a battery management system, a method for controlling a battery management system and a use of the aforementioned.

### BACKGROUND

A battery management system can cover several voltage domains. As an example, the battery management system may cover a high voltage domain and a low voltage domain, which may refer to significantly different voltages. In an automotive application, for instance, the high voltage domain may be responsible for supplying a drive motor of the vehicle, whereas the low voltage domain may be responsible for supplying smaller actuators or sensors. Thus, the battery management system typically comprises several battery management subsystems for monitoring batteries in the different voltage domains. In the end, the entire battery management system is however typically centrally controlled by a superordinate controller which therefore has to communicate with all the battery management subsystems. The communication typically runs via transceivers. Thus, the number of transceivers may match the number of voltage domains covered in the battery management system for communication with all battery management subsystems. As an example, for the above-mentioned high voltage domain and low voltage domain, the controller may comprise two transceivers for communicating with the corresponding high voltage battery management subsystem and lower voltage battery management subsystem, respectively. This requires more area, such as on a chip or on a printed circuit board, and thus increases system cost. Therefore, there is a need for reducing the required area and system cost.

### SUMMARY

In a first aspect, a controller is presented. The controller is configured for controlling a battery management system. The battery management system comprises a plurality of battery management subsystems in at least partially different voltage domains. The controller comprises a transceiver. The transceiver is configured for directly communicating with each battery management subsystem individually.

In a further aspect, a battery management system is presented. The battery management system comprises a plurality of battery management subsystems in at least partially different voltage domains. The battery management system further comprises a controller The controller comprises a transceiver. The transceiver is configured for directly communicating with each battery management subsystem individually.

In a further aspect, a method for controlling a battery management system comprising a plurality of battery management subsystems in at least partially different voltage domains is presented. The method comprises:
a) generating a first item of status information of a first battery of a first battery management subsystem by using a first supervisory circuit of the first battery management subsystem;
b) directly transmitting the first item of status information from the first supervisory circuit to a transceiver of a controller of the battery management system;
c) generating a first item of regulation information by using the controller;
d) directly transmitting the first item of regulation information from the transceiver to the first supervisory circuit;
e) regulating the first battery according to the first item of regulation information by using the first supervisory circuit;
f) generating a second item of status information of a second battery of a second battery management subsystem by using a second supervisory circuit of the second battery management subsystem;
g) directly transmitting the second item of status information from the second supervisory circuit to the transceiver;
h) generating a second item of regulation information by using the controller;
i) directly transmitting the second item of regulation information from the transceiver to the second supervisory circuit; and
j) regulating the second battery according to the second item of regulation information by using the second supervisory circuit.

In a further aspect, a use of a controller and/or of a battery management system and/or of a method for controlling a battery management system is presented for an automotive application.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates an example of a battery management system and a controller according to the present disclosure in a highly schematic fashion;

FIG. 2 schematically illustrates an example of a battery management system comprising a high voltage domain battery management subsystem and a low voltage domain battery management subsystem in further detail; and

FIG. 3 illustrates a flow chart of an example of a method for controlling a battery management system according to the present disclosure.

### DETAILED DESCRIPTION

The examples described herein provide considerable advantages. Specifically, the presented devices and methods may allow to reduce a required area for implementation of a battery management system, such as on a chip or on a printed circuit board, and may thus reduce system cost. More specifically, by using only one transceiver in a controller of the battery management system, the number of components may be reduced while ensuring sufficient communication within the battery management system. The transceiver may enable a multi-path communication to different voltage domains within the battery management system, for instance a dual-path communication to a high voltage domain and a low voltage domain. The transceiver may specifically be directly connected to several battery management subsystems in a star topology for enabling a direct communication with the battery management subsystems individually. Leaving out communication redundancies such as in a ring topology may then even further reduce system cost for less safety critical applications.

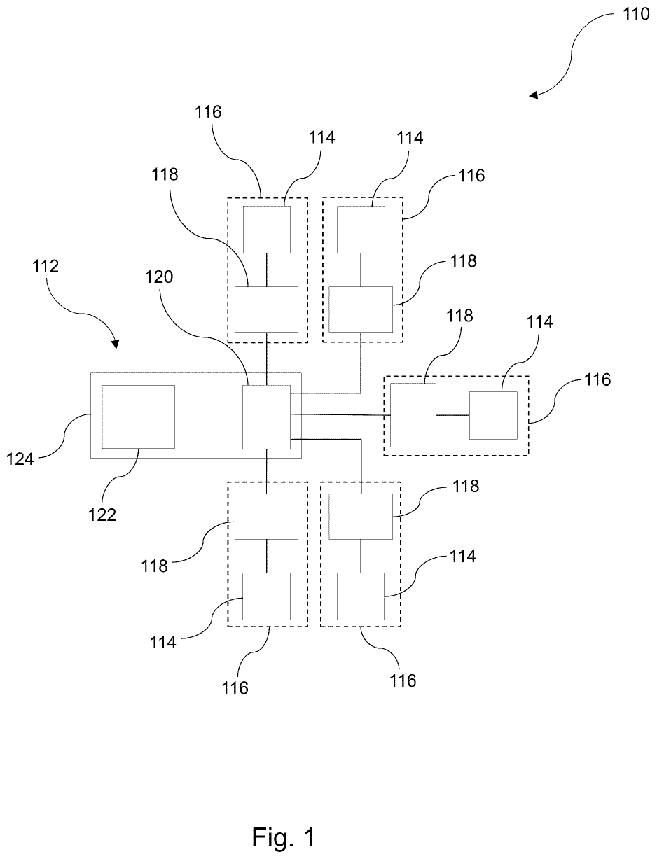

FIG. 1 illustrates an example of a battery management system 110 and a controller 112 in a highly schematic fashion. The battery management system 110 may be configured for monitoring and/or regulating battery characteristics such as voltage, temperature or state of charge, specifically during charging and/or discharging of batteries 114. The battery management system 110 comprises a plurality of battery management subsystems 116 in at least partially different voltage domains. Thus, the battery management system 110 may be a network of the different battery management subsystems 116. Each battery management subsystem 116 may be configured for managing one or more batteries 114. Specifically, each battery management subsystem 116 may be configured for managing one or more batteries 114 in a different voltage domain. In other words, each battery management subsystem 116 may be configured for managing one or more batteries 114 providing different voltages. However, the voltage domains may also at least partially be overlapping. Each battery management subsystem 116 and thus also the superordinate battery management system 110 may comprise one or more batteries 114.

For managing the batteries 114, each battery management subsystem 116 may comprise at least one supervisory circuit 118. Each supervisory circuit 118 may be configured for monitoring one or more batteries 114 or at least a part of a battery 114, such as selected cells of a battery 114 or specific battery characteristics of the battery 114. Thus, the supervisory circuit 118 may be configured for determining an item of status information on a monitored battery 114. Specifically, the supervisory circuit 118 may be configured for measuring battery characteristics, such as voltage or temperature or state of charge. The supervisory circuit 118 may specifically be configured for transmitting the item of status information within the battery management system 110, specifically to the controller 112. The controller 112 comprises a transceiver 120. Thus, the supervisory circuit 118 may more specifically be configured for transmitting the status information to the transceiver 120. Specifically, the controller comprises only one transceiver 120 and not a plurality of transceivers 120 for the plurality of battery management subsystems 116 in the different voltage domains. System cost can be reduced by keeping the number of components low in such fashion.

The transceiver 120 is configured for directly communicating with each battery management subsystem 116 individually, specifically with the supervisory circuit 118 of each battery management subsystem 116. Specifically, the transceiver 120 may be configured for receiving the item of status information on the battery 114. The controller 112 may be a main controller or a host controller of the battery management system 110. Thus, the controller 112 may be configured for controlling the entire battery management system 110 on a superordinate level. Thus, hierarchically, the controller 112 may be superordinate to the supervisory circuits 118. The controller 112 may comprise a microcontroller 122. The controller 112 may further comprise a printed circuit board 124. The microcontroller 122 may be an integrated circuit. The transceiver 120 may also be an integrated circuit. The microcontroller 122 and the transceiver 120 may be arranged on the printed circuit board 124. The microcontroller 122 and the transceiver 120 may also be connected on the printed circuit board 124.

The controller 112 and specifically the microcontroller 122 may be configured for evaluating the item of status information and for generating an item of regulation information for regulating at least one battery 114. The controller 112 may be configured for transmitting the item of regulation information to a supervisory circuit 118 monitoring the respective battery 114. The supervisory circuit 118 may be configured for regulating the respective battery 114. Specifically, the supervisory circuit 118 may be configured for taking regulation actions in case one or more of the battery characteristics exceed predefined thresholds, which may be identified during the evaluation of the controller 112. As an example, such regulation actions may comprise disconnecting and/or connecting the battery 114.

As said, the transceiver 120 is configured for directly communicating with each battery management subsystem 116 individually. Thus, the transceiver 120 may be directly connected to each one of the battery management subsystems 116 individually, specifically to a supervisory circuit 118 of the battery management subsystem 116. Thus, there may be no indirect connection via further elements to the battery management subsystems 116 apart from elements which are required for enabling communication, such as connecting elements or communication devices. Specifically, the transceiver 120 may be directly connected to the supervisory circuit 118 in a wired fashion. The transceiver 120 may be individually connected to a supervisory circuit 118 of each battery management subsystem 116. Thus, the controller 112 may be connecting the battery management subsystems 116 in a star topology, specifically for building a network, in which the controller 112 may be a central hub of the battery management system 110. Thus, there may be a multi-path communication from the controller 112 to the battery management subsystems 116. There may be no direct connections between the individual battery management subsystems 116, such as in a ring topology. The battery management subsystems 116 may only be indirectly connected to each other via the controller 112. This may further reduce system cost, specifically in less safety critical applications which may require additional redundancies such as in a ring topology.

The battery management system 110 or at least the controller 112 may comply with safety integrity level 2 or lower but not higher, specifically with automotive safety integrity level B or lower but not higher. The IEC 61508 standard defines four safety integrity levels for functional safety, with safety integrity level 4 being the most dependable, followed by safety integrity level 3, then safety integrity level 2 and lastly safety integrity level 1 being the least dependable. Accordingly, the ISO 26262 standard defines four automotive safety integrity levels for the field of automotive with automotive safety integrity level D having the highest safety requirements, followed by automotive safety integrity level C, then automotive safety integrity level B and lastly automotive safety integrity level A having the lowest safety requirements. As an example, automotive safety integrity level D refers to likely potential for severely life-threatening or fatal injury in case of a failure event, e.g. a loss of braking on all wheels of a car, and thus requires the highest safety level. Automotive safety integrity level B for instance refers to a loss of headlights or brake lights.

The transceiver 120 may be configured for bidirectionally communicating with the battery management subsystems 116 and specifically with the respective supervisory circuits 118 of the battery management subsystems 116 as already indicated. Thus, both the transceiver 120 and the supervisory circuit 118 may transmit and receive signals. Specifically, the supervisory circuit 118 may generate an item of status information on a monitored battery 114 and may transmit the item of status information to the transceiver 120. The transceiver 120 may receive the item of status information. The item of status information may be represented as an analog signal. Within the controller 112, the transceiver 120 may interpret the analog signal and may send a corresponding digital signal to the microcontroller 122, such as via one or more universal asynchronous receiver transmitter lines. The microcontroller 122 may then evaluate the item of status information and may generate a corresponding item of regulation information if required. The item of regulation information may subsequently be transmitted to the supervisory circuit 118 via the transceiver 120 in reverse order, such that the supervisory circuit 118 can regulate the battery 114 accordingly.

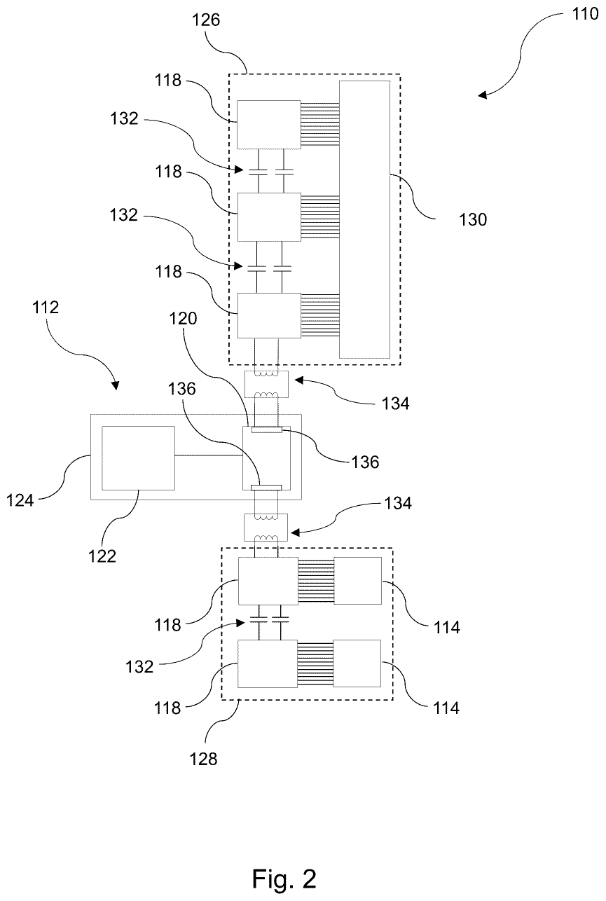

FIG. 2 schematically illustrates in further detail an example of a battery management system 110 comprising a high voltage domain battery management subsystem 126 and a low voltage domain battery management subsystem 128. The battery management system 110 may specifically comprise a high voltage battery management subsystem 126 and a low voltage battery management subsystem 128 for significantly different voltage domains. Nevertheless, for the description of FIG. 2, reference may also be made to the description of FIG. 1 at least to a large extent. The high voltage domain battery management subsystem 126 may be a battery management subsystem 116 as described in FIG. 1. The low voltage domain battery management subsystem 128 may also be a battery management subsystem 116 as described in FIG. 1. The high voltage battery management subsystem 126 may specifically be configured for managing one or more batteries 114 in a high voltage domain. The low voltage battery management subsystem 128 may specifically be configured for managing one or more batteries 114 in a low voltage domain.

The high voltage domain and the low voltage domain may comprise different voltages or in other words batteries 114 providing different voltages. The high voltage domain may comprise higher voltages compared to the low voltage domain. The low voltage domain may comprise lower voltages compared to the high voltage domain. In an automotive application, the high voltage domain may comprise voltages configured for supplying a drive motor of a vehicle. As an example, the high voltage domain may comprise voltages of 400 V and above, specifically 200 V and above, more specifically 100 V and above. The low voltage domain may comprise voltages configured for supplying at least one of a sensor, an actuator, a lighting device and a communication device of a vehicle. As an example, the low voltage domain may comprise voltages of 48 V and below, specifically 24 V and below, more specifically 12 V and below. Other options may of course also be possible.

As shown in FIG. 2, some batteries 114 may be bundled in a battery stack 130, such as in the high voltage domain for reaching higher voltages. The battery stack 130 may be monitored by one or specifically also by more than one supervisory circuit 118. Thus, one supervisory circuit 118 may monitor selected batteries 114 or even cells or even selected battery characteristics only. The supervisory circuits 118 in one battery management subsystem 116 may be connected to each other, e.g. in series, wherein one supervisory circuit 118 may be connected to the transceiver 120. As an example, the supervisory circuits 118 may be connected to each other via capacitors 132 for capacitive coupling. In other words, the battery management subsystem 116 may comprise capacitors 132 arranged between the supervisory circuits 118. Further, the battery management system 110 may comprise transformers 134 arranged between the controller 112 and the battery management subsystems 116 or at least some of the battery management subsystems 116, such as for inductive coupling. Specifically, the transformers 134 may be arranged between the transceiver 120 and one supervisory circuit 118 of each battery management subsystem 116. Generally, other types of coupling may of course also be possible between the transceiver 120 and the supervisory circuits 118 as well as between the individual supervisory circuits 118.

The transceiver 120 may comprise a plurality of communication ports 136. Each communication port 136 may be configured for being connected to a different battery management subsystem 116, specifically to a supervisory circuit 118 of the battery management subsystem 116. As shown in FIG. 2, the transceiver 120 may specifically comprise one communication port 136 connected to the high voltage domain battery management subsystem 126 and one communication port 136 connected to the low voltage domain battery management subsystem 128. Specifically, one communication port 136 may be connected to a supervisory circuit 118 of the high voltage domain battery management subsystem 126 and one communication port 136 may be connected to a supervisory circuit 118 of the low voltage domain battery management subsystem 128, such as via transformers 134. Thus, only one transceiver 120 using several communication ports 136 may be feasible for enabling communication with several battery management subsystems 116. This allows to reduce system cost by saving additional transceivers 120.

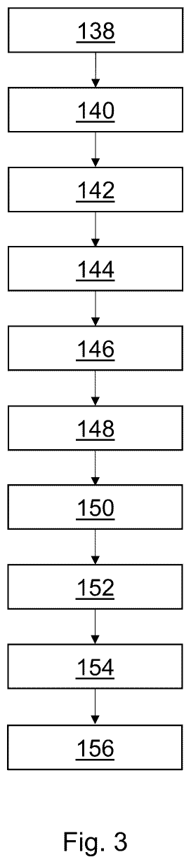

FIG. 3 illustrates a flow chart of an example of a method for controlling a battery management system 110 comprising a plurality of battery management subsystems 116 in at least partially different voltage domains. The method comprises the following method steps. The presented method steps may be performed in the indicated order. It shall be noted, however, that a different order may also be possible. The method may comprise further method steps which are not listed. Further, one or more of the method steps may be performed once or repeatedly. Further, two or more of the method steps may be performed simultaneously or in a timely overlapping fashion. The method may at least partially be computer-implemented. Thus, one or more of the following method steps may be computer-implemented.
a) (denoted by reference numeral 138) generating a first item of status information of a first battery 114 of a first battery management subsystem 116 by using a first supervisory circuit 118 of the first battery management subsystem 116;
b) (denoted by reference numeral 140) directly transmitting the first item of status information from the first supervisory circuit 118 to a transceiver 120 of a controller 112 of the battery management system 110;
c) (denoted by reference numeral 142) generating a first item of regulation information by using the controller 112;
d) (denoted by reference numeral 144) directly transmitting the first item of regulation information from the transceiver 120 to the first supervisory circuit 118;
e) (denoted by reference numeral 146) regulating the first battery 114 according to the first item of regulation information by using the first supervisory circuit 118;
f) (denoted by reference numeral 148) generating a second item of status information of a second battery 114 of a second battery management subsystem 116 by using a second supervisory circuit 118 of the second battery management subsystem 116;
g) (denoted by reference numeral 150) directly transmitting the second item of status information from the second supervisory circuit 118 to the transceiver 120;
h) (denoted by reference numeral 152) generating a second item of regulation information by using the controller 112;
i) (denoted by reference numeral 154) directly transmitting the second item of regulation information from the transceiver 120 to the second supervisory circuit 118; and
j) (denoted by reference numeral 156) regulating the second battery 114 according to the second item of regulation information by using the second supervisory circuit 118.

Generally, the terms first, second and, if applicable, further numberings are merely used herein as nomenclature, without indicating an order or ranking. The terms first, second and, if applicable, further numberings are only used for indicating that different elements of the same kind are referred to. Thus, the above-mentioned first and second battery management subsystems 116 may be separate battery management subsystems 116. However, both may be connected to the only used transceiver 120. Specifically, the above-mentioned first battery management subsystem 116 may be the high voltage battery management subsystem 126 and the second battery management subsystem 116 may be the low voltage battery management subsystem 128 shown in FIG. 2. Steps b), d), g) and i) may further comprise transforming a voltage between two voltage levels by using the transformers 134.

The controller 112, the battery management system 110 and/or the method for controlling the battery management system 110 may specifically be used in an automotive application. Thus, the controller 112, the battery management system 110 and/or the method for controlling the battery management system 110 may be used for battery management in a vehicle, specifically for managing batteries 114 in different voltage domains within a vehicle.

In addition to the above-described examples, the following examples are disclosed herein:

### EXAMPLE 1

A controller configured for controlling a battery management system comprising a plurality of battery management subsystems in at least partially different voltage domains, wherein the controller comprises a transceiver configured for directly communicating with each battery management subsystem individually.

### EXAMPLE 2

The controller according to the preceding Example, wherein the controller is configured for interconnecting the battery management subsystems in a star topology.

### EXAMPLE 3

The controller according to any one of the preceding Examples, wherein the controller is configured for being a central hub of the battery management system.

### EXAMPLE 4

The controller according to any one of the preceding Examples, wherein the controller, specifically the transceiver, is configured for being directly connected to each one of the battery management subsystems, specifically in a wired fashion.

### EXAMPLE 5

The controller according to any one of the preceding Examples, wherein the transceiver comprises a plurality of communication ports, wherein each communication port is configured for being connected to a different battery management subsystem, specifically to a supervisory circuit of the battery management subsystem.

### EXAMPLE 6

The controller according to any one of the preceding Examples, wherein each battery management subsystem manages one or more batteries in a different voltage domain.

### EXAMPLE 7

The controller according to any one of the preceding Examples, wherein the battery management system comprises a high voltage battery management subsystem managing one or more batteries in a high voltage domain and a voltage battery management subsystem managing one or more batteries in a low voltage domain.

### EXAMPLE 8

The controller according to the preceding Example, wherein the transceiver is configured for directly communicating with the high voltage battery management subsystem and with the low voltage battery management subsystem individually.

### EXAMPLE 9

The controller according to the preceding Example, wherein the controller, specifically the transceiver, is configured for being directly connected to each one of the high voltage battery management subsystem and the low voltage battery management subsystem, specifically in a wired fashion.

### EXAMPLE 10

The controller according to any one of the two preceding Examples, wherein the high voltage domain and the low voltage domain comprise different voltages.

### EXAMPLE 11

The controller according to any one of the three preceding Examples, wherein the high voltage domain comprises voltages configured for supplying a drive motor of a vehicle.

### EXAMPLE 12

The controller according to any one of the four preceding Examples, wherein the low voltage domain comprises voltages configured for supplying at least one of a sensor, an actuator, a lighting device and a communication device of a vehicle.

### EXAMPLE 13

The controller according to any one of the five preceding Examples, wherein the high voltage domain comprises voltages of 400 V and above, specifically 200 V and above, more specifically 100 V and above.

### EXAMPLE 14

The controller according to any one of the six preceding Examples, wherein the low voltage domain comprises voltages of 48 V and below, specifically 24 V and below, more specifically 12 V and below.

### EXAMPLE 15

The controller according to any one of the preceding Examples, wherein the transceiver is configured for bidirectionally communicating with the battery management subsystems.

### EXAMPLE 16

The controller according to any one of the preceding Examples, wherein the controller complies with safety integrity level 2 or lower but not higher, specifically with automotive safety integrity level B or lower but not higher.

### EXAMPLE 17

The controller according to any one of the preceding Examples, wherein the transceiver is an integrated circuit.

### EXAMPLE 18

The controller according to any one of the preceding Examples, further comprising a microcontroller.

### EXAMPLE 19

The controller according to any one of the preceding Examples, further comprising a printed circuit board.

### EXAMPLE 20

A battery management system comprising a plurality of battery management subsystems in at least partially different voltage domains and a controller comprising a transceiver configured for directly communicating with each battery management subsystem individually.

### EXAMPLE 21

The battery management system according to the preceding Example, wherein the controller is a controller according to any one of the preceding Examples referring to a controller.

### EXAMPLE 22

The battery management system according to any one of the preceding Examples referring to a battery management system, wherein the battery management system is arranged in a star topology.

### EXAMPLE 23

The battery management system according to the preceding Example, wherein the controller is a central hub within the star topology.

### EXAMPLE 24

The battery management system according to any one of the preceding Examples referring to a battery management system, wherein each battery management subsystem is directly connected to the controller, specifically in a wired fashion.

### EXAMPLE 25

The battery management system according to any one of the preceding Examples referring to a battery management system, wherein each battery management subsystem is configured for managing batteries in a different voltage domain.

### EXAMPLE 26

The battery management system according to any one of the preceding Examples referring to a battery management system, wherein the battery management system comprises a high voltage battery management subsystem configured for managing one or more batteries in a high voltage domain and a low voltage battery management subsystem configured for managing one or more batteries in a low voltage domain.

### EXAMPLE 27

The battery management system according to the preceding Example, wherein the controller, specifically the transceiver, is directly connected to each one of the high voltage battery management subsystem and the low voltage battery management subsystem.

### EXAMPLE 28

The battery management system according to any one of the preceding Examples referring to a battery management system, wherein each battery management subsystem comprises at least one supervisory circuit configured for monitoring one or more batteries.

### EXAMPLE 29

The battery management system according to any one of the preceding Examples referring to a battery management system, wherein each battery management subsystem comprises one or more batteries.

### EXAMPLE 30

The battery management system according to any one of the preceding Examples referring to a battery management system, wherein at least one battery management subsystem comprises a plurality of batteries bundled in a battery stack, wherein the battery stack is specifically monitored by one or more supervisory circuits.

### EXAMPLE 31

The battery management system according to any one of the preceding Examples referring to a battery management system, further comprising transformers arranged between the controller and the battery management subsystems or at least a part thereof.

### EXAMPLE 32

The battery management system according to any one of the preceding Examples referring to a battery management system, wherein the battery management system complies with safety integrity level 2 or lower but not higher, specifically with automotive safety integrity level B or lower but not higher.

### EXAMPLE 33

A method for controlling a battery management system comprising a plurality of battery management subsystems in at least partially different voltage domains, the method comprising:
a) generating a first item of status information of a first battery of a first battery management subsystem by using a first supervisory circuit of the first battery management subsystem;
b) directly transmitting the first item of status information from the first supervisory circuit to a transceiver of a controller of the battery management system;
c) generating a first item of regulation information by using the controller;
d) directly transmitting the first item of regulation information from the transceiver to the first supervisory circuit;
e) regulating the first battery according to the first item of regulation information by using the first supervisory circuit;
f) generating a second item of status information of a second battery of a second battery management subsystem by using a second supervisory circuit of the second battery management subsystem;
g) directly transmitting the second item of status information from the second supervisory circuit to the transceiver;
h) generating a second item of regulation information by using the controller;
i) directly transmitting the second item of regulation information from the transceiver to the second supervisory circuit; and
j) regulating the second battery according to the second item of regulation information by using the second supervisory circuit.

### EXAMPLE 34

The method according to the preceding Example, wherein the battery management system is a battery management system according to any one of the preceding Examples referring to a battery management system.

### EXAMPLE 35

The method according to any one of the preceding method Examples, wherein the controller is a controller according to any one of the preceding Examples referring to a controller.

### Example 36

The method according to any one of the preceding method Examples, wherein the first battery management subsystem and the second battery management subsystem are separate battery management subsystems.

### EXAMPLE 37

The method according to any one of the preceding method Examples, wherein the first battery management subsystem is a high voltage battery management subsystem and the second battery management subsystem is a low voltage battery management subsystem.

### EXAMPLE 38

The method according to any one of the preceding method Examples, wherein steps b), d), g) and i) comprise transforming a voltage between two voltage levels by using a transformer of the battery management system.

### EXAMPLE 39

The method according to any one of the preceding method Examples, wherein the method is at least partially computer-implemented.

### EXAMPLE 40

A use for an automotive application of at least one of a controller according to any one of the preceding Examples referring to a controller, a battery management system according to any one of the preceding Examples referring to a battery management system and a method according to any one of the preceding method Examples.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the disclosure and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the disclosure, as well as specific examples thereof, are intended to encompass equivalents thereof.

1. A controller configured for controlling a battery management system comprising a plurality of battery management subsystems in at least partially different voltage domains, wherein the controller comprises a transceiver configured for directly communicating with each battery management subsystem individually.

2. The controller of claim 1, wherein the controller is configured for interconnecting the battery management subsystems in a star topology.

3. The controller of claim 1, wherein the controller is configured for being a central hub of the battery management system.

4. The controller of claim 1, wherein the controller, specifically the transceiver, is configured for being directly connected to each one of the battery management subsystems, specifically in a wired fashion.

5. The controller of claim 1, wherein the transceiver comprises a plurality of communication ports, wherein each communication port is configured for being connected to a different battery management subsystem, specifically to a supervisory circuit of the battery management subsystem.

6. The controller of claim 1, wherein the battery management system comprises a high voltage battery management subsystem managing one or more batteries in a high voltage domain and a low voltage battery management subsystem managing one or more batteries in a low voltage domain.

7. The controller of claim 1, wherein the transceiver is configured for directly communicating with the high voltage battery management subsystem and with the low voltage battery management subsystem individually.

8. The controller of claim 1, wherein the controller, specifically the transceiver, is configured for being directly connected to each one of the high voltage battery management subsystem and the low voltage battery management subsystem, specifically in a wired fashion.

9. The controller of claim 1, wherein the transceiver is configured for bidirectionally communicating with the battery management subsystems.

10. The controller of claim 1, wherein the controller complies with safety integrity level 2 or lower but not higher, specifically with automotive safety integrity level B or lower but not higher.

11. The controller of claim 1, wherein the transceiver is an integrated circuit.

12. A battery management system comprising a plurality of battery management subsystems in at least partially different voltage domains and a controller comprising a transceiver configured for directly communicating with each battery management subsystem individually.

13. The battery management system of claim 12, wherein each battery management subsystem is directly connected to the controller, specifically in a wired fashion.

14. The battery management system of claim 12, wherein the battery management system comprises a high voltage battery management subsystem configured for managing one or more batteries in a high voltage domain and a low voltage battery management subsystem configured for managing one or more batteries in a low voltage domain, wherein the controller, specifically the transceiver, is directly connected to each one of the high voltage battery management subsystem and the low voltage battery management subsystem.

15. The battery management system of claim 12, wherein each battery management subsystem comprises at least one supervisory circuit configured for monitoring one or more batteries.

16. The battery management system of claim 12, further comprising transformers arranged between the controller and the battery management subsystems or at least a part thereof.

17. The battery management system of claim 12, wherein the battery management system complies with safety integrity level 2 or lower but not higher, specifically with automotive safety integrity level B or lower but not higher.

18. A method for controlling a battery management system comprising a plurality of battery management subsystems in at least partially different voltage domains, the method comprising:
a) generating a first item of status information of a first battery of a first battery management subsystem by using a first supervisory circuit of the first battery management subsystem;
b) directly transmitting the first item of status information from the first supervisory circuit to a transceiver of a controller of the battery management system;
c) generating a first item of regulation information by using the controller;
d) directly transmitting the first item of regulation information from the transceiver to the first supervisory circuit;
e) regulating the first battery according to the first item of regulation information by using the first supervisory circuit;
f) generating a second item of status information of a second battery of a second battery management subsystem by using a second supervisory circuit of the second battery management subsystem;
g) directly transmitting the second item of status information from the second supervisory circuit to the transceiver;
h) generating a second item of regulation information by using the controller;
i) directly transmitting the second item of regulation information from the transceiver to the second supervisory circuit; and
j) regulating the second battery according to the second item of regulation information by using the second supervisory circuit.

19. The method of claim 18, wherein the first battery management subsystem is a high voltage battery management subsystem and the second battery management subsystem is a low voltage battery management subsystem.

20. The method of claim 18, further comprising: using the method for an automotive application.
